(19) United States
(12) Patent Application Publication
(10) Pub. No.: US 2009/0034279 A1
(43) Pub. Date: Feb. 5, 2009

(54) DEVICE FOR MOUNTING AN OPTICAL MODULE IN A HEADLIGHT FOR A MOTOR VEHICLE

(75) Inventors: Jonathan BLANDIN, LES PAVILLONS SOUS BOIS (FR); Philippe ARLON, OZOIR LA FERRIERE (FR); Olivier BON, PARIS (FR); David DORN, VILLEPINTE (FR); Remi LETOUMELIN, CHESSY (FR); Herve LOUVIOT, PANTIN (FR); Philippe NATCHOO, ROISSY en BRIE (FR); Daniel SOLEILHAVOUP, MITRY MORY (FR)

Correspondence Address: MATTHEW R. JENKINS, ESQ., 2310 FAR HILLS BUILDING, DAYTON, OH, 45419, US

(73) Assignee: VALEO VISION, Bobigny Cedex (FR)

(21) Appl. No.: 12/182,295

(22) Filed: Jul. 30, 2008

(30) Foreign Application Priority Data
Aug. 3, 2007 (FR) 07 05 716

(51) Int. Cl. F21V 21/14

(52) U.S. Cl. 362/512

(57) ABSTRACT

A headlight for a motor vehicle equipped with an optical module comprising a support carrying a light source and an optical system for emitting a light beam, the optical module being mounted so as to be able to move on the headlight about a pivot axis by means of mobility means that associate means of pivotal mounting of the support on a chassis of the headlight using an actuator in relationship with at least one drive member in engagement on the support. The means of pivotal mounting of the support comprise a single articulation bearing: situated below and supporting the optical module, taking up the forces, in particular axial and radial, due to the optical module and thus separating the drive member or members of the force chains.

### CROSS-REFERENCE TO RELATED APPLICATIONS

This application claims priority to French Application No. 0705716 filed Aug. 3, 2007, which application is incorporated herein by reference and made a part hereof.

### BACKGROUND OF THE INVENTION

1. Field of the Invention

The invention lies in the field of headlights for motor vehicles, and more particularly relates to methods of installing an optical module pivotally inside the headlight. It has as its object such a headlight in which the optical module is more particularly of the low light type and is able to pivot along the path followed by the vehicle, in particular in the case of taking a bend in order to obtain a so-called “bending light” function (also referred to as DBL, standing for “Dynamic Bending Light”).

2. Description of the Related Art

A headlight for a motor vehicle generally comprises a housing on which there is mounted a chassis carrying an optical module generating a light beam, closed by a transparent lens (allowing the light to pass substantially) for the exit of the light beam. This optical module comprises a support for a light source and means of forming a light beam from the light produced by the light source. The light source may be a discharge lamp, a halogen lamp or a light emitting diode (also referred to as an LED, standing for “Light Emitting Diode” in English) for example. The means of forming the light beam normally comprise an optical system carried by the support. Such an optical system is of the type comprising one or more associated optical elements, such as a reflector and/or dioptric element of the lens type, a Fresnel lens in particular, and/or a light collimating element for example.

One example of an optical module is a so-called elliptical module: in this type of module, a light concentration spot is generated by a light source disposed in a mirror, or reflector. Typically, the light source is disposed at the first focus, or object focus, of a mirror in the form of an ellipsoid, the spot forming at the second focus, or image focus, of the mirror. The light concentration spot is then projected onto the road by a convergent lens, for example a lens of the plano-convex type. In order to obtain a cutoff beam, a cover is inserted in a known fashion at the focus of the lens.

The optical module is also provided with connections for connecting the light source to the electrical energy source of the vehicle. The functioning of the light source can also be controlled by electronic control means, which may be located in any point on the vehicle or be integrated in the headlight.

The problem is posed of the lighting of the road when the vehicle is approaching a bend. This problem concerns more particularly headlights equipped with an optical module dedicated to the projection of a passing, or low, light, or other headlights with a similar cutoff. Such headlights with cutoff are organized so as not to dazzle the driver of a vehicle being passed. In the case of taking a bend, it is useful to illuminate the road by projecting a light beam in the direction of the bend taken by the vehicle.

One solution consists of mounting the optical module pivotally on the chassis (also referred to as the plate) of the headlight, about a pivot axis oriented orthogonally to the axis of the light beam produced by the optical module. This pivot axis is in particular oriented substantially along the vertical with respect to the resting plane of the vehicle on the ground. Such pivoting mounting of the optical module makes it possible to fulfill a so-called “bending light” function or DBL function (Dynamic Bending Light in English). The optical module is able to move pivotally on each side of a median position in which the emission axis of the light beam corresponds to the median (longitudinal) general axis of the vehicle. A pivoting of the optical module with respect to its median position makes it possible to modify the orientation of the light beam produced by the optical module along the path of the vehicle, in particular when taking a bend. The pivoting mounting of the optical module is achieved by means of its support, which is articulated on the chassis and is placed in a longitudinal median zone of the optical module so as best to distribute the weight of the latter on each side of the support. The longitudinal extension of the optical module corresponds to the orientation of the light beam that it produces. The chassis is arranged in a frame forming a pair of opposite articulation bearings that are distributed on each side of the support along its articulation axis. An actuator carried by the chassis drives the support pivotally according to control information coming from the vehicle, the steering wheel angle sensor for example. Transmission means are interposed between the actuator and the support in order to put them in relationship with each other.

The functional members of the headlight are deemed to be unaesthetic, and masks are interposed between the transparent lens and these functional members, such as the chassis, the optical module, the connection elements and its pivotal mobility means. The masks are arranged and disposed in relation to each other so as to clad the internal faces of the headlight that are visually accessible through the transparent lens. These masks associate in particular at least one movable mask carried by the optical module and at least one fixed mask carried by the headlight housing. A window is provided in the fixed mask to allow the passage of the light beam from the optical module to the transparent wall. The masks extend between the rear of the headlight and its front face provided with the transparent glass in order to reveal only the space reserved for the exit of the light beam out of the headlight.

The problem posed for the pivoting mounting of the optical module on the chassis lies in a satisfactory compromise to be found with regard to several constraints. The optical module must be held reliably and precisely inside the headlight, taking into account in particular its weight and axial extension.

A capability of pivotal mobility of the optical module with optimized angular movement is also sought, through simple and inexpensive means. However, optimization of this angular movement causes a necessary clearance between the fixed mask and the movable mask that is unaesthetic and does promote compactness of the assembly. It is frequently necessary to interpose intermediate masks, which is not desirable because of the complexity and costs caused for the headlight. In general terms, the pivotal mobility of the optical module makes it difficult to install the masks and a compromise must be found between optimization of the angular movement of the optical module and the location of the masks forming between them a reduced clearance.

The organization of the functional means of the headlight, and in particular the methods of mounting and optimized pivotal maneuvering of the optical module on the chassis must be obtained with as small a space requirement as possible. The arrangement of the means used for the pivotal mounting of the optical module must facilitate the masking of the functional members of the headlight deemed to be unaesthetic and offer the designers freedom of conformation of the headlight with regard to its external appearance and the visual effect that it procures for the vehicle.

The methods of pivotal mounting of the optical module on the chassis must take into account the behavior of the headlight in the event of “pedestrian impact” (“pedestrian impact” means the possibility of the headlight best absorbing an impact during a collision with a pedestrian, in order to limit physical injury, and European regulations have recently been drawn up on this subject), and more particularly must allow easy retraction of the optical module without affecting the quality and precision of its maintaining in the functional position.

### SUMMARY OF THE INVENTION

An object of the present invention is a motor vehicle headlight that is arranged to receive pivotally an optical module producing a light beam in order to confer on the headlight the so-called “bending light” function. More particularly, an aim of the present invention is to propose a device for mounting the optical module on a chassis of the headlight, the organization of which procures a satisfactory compromise with regard to the constraints stated. The present invention also aims to propose a headlight whose global arrangement best exploits the advantages procured by this mounting device with which it is equipped.

The object of the present invention is a headlight for a motor vehicle equipped with an optical module comprising a support carrying a light source and an optical system for emission of a light beam, the optical module being mounted so as to be able to move on the headlight about a pivot axis through mobility means that associate means of pivoting mounting of the support on a chassis of the headlight using an actuator in relationship with a driving member in engagement on the support. The pivoting mounting means for the support comprise a pedestal supporting the optical module that provides a seat on which the support rests and that is provided with a single bearing for articulation of the support on the chassis.

The invention thus concerns a headlight for motor vehicle equipped with an optical module comprising a support carrying a light source and an optical system for emitting a light beam, the optical module being mounted so as to be able to move on the headlight about a pivot spindle by means of mobility means that associate means for the pivotal mounting of the support on a chassis of the headlight using an actuator in relationship with at least one drive member in engagement on the support, the pivotal mounting means of the support (6) comprising a single articulation bearing:

situated below and supporting the optical module;

taking up the forces, in particular axial and radial, due to the optical module and thus separating the members driving the force chains.

The movable mounting of the optical module is able to confer on the headlight a so-called “bending light” function, which consists of causing a pivoting of the optical module about its pivot axis according to the path followed by the vehicle, and more particularly when the vehicle is approaching a bend. The pivot axis is oriented transversely to the optical axis of the light beam and more particularly substantially orthogonally to a plane corresponding to the resting plane of the vehicle on the ground when the headlight is installed on this vehicle. The pivoting of the optical module is more particularly achieved from its angular movement about the pivot axis, on each side of a median idle position corresponding to a path of the vehicle caused by putting its steered wheels in parallel or corresponding to the longitudinally median general axis of the vehicle. The use of the actuator is in particular caused by a control means integrating means of detecting the taking of a bend by the vehicle.

The optical module constitutes a module able to emit at least one light beam, which is installed inside the headlight. More particularly, the headlight comprises a housing for receiving the optical module, this housing being provided with the chassis that carries at least the support by means of the articulation bearing, or even also the actuator and the driving member that is associated with it and that is in engagement on the support in order to cause the pivoting of the optical module. The optical module is able to comprise one or more light sources and one or more optical systems allocated to at least one of these light sources. The optical system comprises one or more optical elements for emitting one or more light beams that are directed towards a transparent lens equipping the headlight at the front. Such optical elements are for example at least any one among a reflector and/or a dioptric element of the lens type, a Fresnel lens in particular, and/or a light-collimating element for example. Such optical elements are chosen according to the type of light source with which the optical module is provided and with which they are associated.

The housing comprises a front face provided with a transparent lens for passage of the light beam through it, and houses one or more masks disposed inside the housing. This mask or masks delimit, opposite the transparent wall, the edges of a window for passage of the light beam towards this transparent wall. These masks form visual obstacles for an observer from the outside of the headlight through the transparent lens, and are able to make the functional members of the headlight invisible for such an observer. The functional members of the headlight are understood to be the members deemed to be unaesthetic and useful to its function, namely all the members housed by the housing of the headlight except for at least the masks themselves and the transparent lens.

The actuator is able to maneuver the module constituting the optical module by means of the support. This support is a member that is placed interposed between the functional components of the optical module and the chassis. The functional components of the optical module are understood to be those useful to the emission of at least one light beam, a light source and optical system in particular. The actuator and support are in relationship through a transmission system comprising the transmission member, or even also intermediate transmission members interposed between the actuator and the transmission member in engagement on the support.

According to the present invention, a choice is proposed consisting of articulating the support on a foundation of the optical module on which the latter rests through a single articulation bearing. More particularly, the headlight is mainly recognizable in that the pivoting mounting means of the support comprise essentially a pedestal supporting the optical module. This pedestal forms a seat on which the support rests and is provided with a single articulation bearing for the support on the chassis. This single articulation bearing is able by itself to guide the optical module pivotally from a mobility of the support supported by the pedestal.

The articulation bearing is composed of a male articulation member and a female articulation member cooperating with each other, which are allocated to the support and chassis. The articulation member allocated to the chassis cooperates with the articulation member allocated to the support, these articulation members indifferently being respectively male or female. The female articulation member is in particular arranged in a cage receiving a finger, or even a sphere, constituting the male articulation member. The articulation bearing is in general terms arranged as nested members that are respectively allocated to the support and chassis so as to be able to procure guidance of the support in mobility on the chassis causing a pivoting of the optical module about the pivot axis.

According to various variant embodiments, the axis of the articulation bearing is at least parallel to the pivot axis of the optical module while being off-center with respect to this pivot axis, or is coaxial with this pivot axis. The latter solution has the advantage of simplifying the organization of the pedestal and the methods of putting the support and the actuator in relationship with each other.

The pedestal forms a foundation for the optical module that it supports by means of the seat and that it guides pivotally by means of the single articulation bearing, to the exclusion of any other articulation bearing. Such an organization of the pivoting mounting means of the optical module is able to best leave clear its close surroundings.

These arrangements are such that the means of pivoting mounting of the support on the chassis have no members placed around the optical module with the exception of its natural resting base when the headlight is installed on a vehicle. More particularly, the upper zone of the optical module, opposite its lower zone resting on the pedestal, is able to be free of any functional member liable to be interposed between the optical module and at least one mask of the headlight.

The mounting means are structurally simple and overall reduced to the pedestal associating the seat and the single articulation bearing with which it is provided. The pivotal mobility means of the optical module are obtained at less cost and with a reduced space requirement. In addition, the chassis reduced to the pedestal can easily be installed inside the headlight according to any arrangement, being housed in its lower zone, which can easily be masked. Such a chassis can be located extending overall in a plane in any orientation, and in particular in an orientation different from that of a plane orthogonal to the optical axis of the optical module. Such freedom of orientation does not affect the obtaining of an appropriate optimized angular movement of the optical module, with the advantage of being able to obtain, in a cumulative fashion, the “conventional low” function and the “bending light” function from one and the same light source and one and the same optical module. The chassis is able to be inclined to a greater or lesser extent with respect to the general movement axis of the vehicle, to facilitate its installation according to any conformation of the transparent lens: it can thus follow or be close to the curvature of the lens for better visual effect.

More particularly, the headlight is provided with an optical module mounted so as to pivot on the pedestal in an angular movement able to procure, from this same optical module, the “conventional low” function and the “bending light” function. The “conventional low” function corresponds to an orientation of the optical module procuring an emission of the light beam along an optical axis parallel to the median axis of the vehicle (its longitudinal axis) or in other words to its general axis of movement in a straight line.

The capacity for pivoting of the optical module is improved by virtue of the invention. The pivotal mounting of the support from the pedestal, or even also the invisibility of the clearances between fixed mask and movable mask, improves the angular pivotal movement of the optical module with respect to its median position on the chassis. This angular movement is able to be as much as 60°, preferably being limited to 45° in order to facilitate the mask installation and conformation methods. The possibility of a large pivotal movement of the optical module (and which is not obtained to the detriment of compactness) makes it possible to make the light source able by itself to illuminate the road when the vehicle takes a bend in order to obtain the said “bending light” function. This property makes it possible in particular to exempt the vehicle from having to be equipped with a light source additional to the optical module and activatable conjointly with its light source or specifically for obtaining the “bending light” function.

The proposed methods of organizing the mobility means of the optical module make it possible to reduce the resistance force opposed by the optical module in the case of “pedestrian impact”, by facilitating the deformation of the headlight. More particularly, the mounting of the optical module using a pedestal facilitates its retraction by flexion in the area of the articulation bearing in the event of “pedestrian impact”. This retraction capacity of the optical module is obtained without impairing the reliability and precision of the holding and pivotal mobility of the optical module inside the headlight. There are in fact two beneficial effects on “pedestrian impact”, namely the relative arrangement of the parts of the module and the very form of the said parts, which help to increase its capacity to deform under an impact.

The optical module is in particular disposed above, in particular in cantilever over or overhanging, the chassis, which is formed by a framework provided with the pedestal at its top. The overhanging area of the chassis is the one that is situated above the chassis in the position of installation of the headlight on a vehicle. The concept of overhanging does not prejudice the extension of the optical module in this area situated above the chassis, and the optical module may or may not project beyond a point vertically in line with the chassis.

The framework consists for example of a plate, or a frame of the type composed of beams connected together. Such a frame comprises, and preferably consists of, a single part than can easily be obtained by molding and/or insert molding of one or more plastics materials. The framework is provided with means of fixing to a housing of the headlight and means of receiving the actuator constituting the mobility of the optical module.

The articulation axis of the bearing is either coaxial or off-center in parallel with respect to the pivot axis of the optical module.

According to an embodiment in which the articulation axis of the bearing is coaxial with the pivot axis of the optical module, the chassis, which is advantageously formed by a framework, extends in a plane containing the pivot axis.

According to various variant embodiments, the chassis may be a global chassis used for one or more optical modules allocated functions that are dedicated to them. The chassis may also be an intermediate chassis carried by such a global chassis, where necessary by means of mobility means.

If it is chosen to carry the module of the invention by means of an intermediate chassis, it is then possible to allocate to it a dedicated (dynamic or static) leveler, a leveler that can of course be used firstly for effecting the adjustment of attitude of the module, but also for intentionally offsetting the beam, for example to obtain with the same module a beam raised compared with a beam of the motorway beam type (known by the English term “motorway” beam): a leveler of the dynamic type is then rather used.

If it is chosen to carry the module according to the invention by means of a chassis common to several modules, in this case use is made of a leveler common to all the modules carried by the chassis.

It should be noted that it is possible to use the term “plate” indifferently in place of “chassis” throughout the present text.

The pedestal comprises a passage for the driving member that is coaxial with the axis of the articulation bearing. The driving member constitutes the articulation bearing and can be maneuvered in rotation on itself by the actuator.

The driving member constitutes the articulation bearing in that it forms one of the articulation members that makes it up. The driving member is indifferently a female member and/or a male member, which is in engagement on the support by means of the complementary-shaped articulation member allocated to the support. The methods of engaging the driving member on the support are indifferent provided that this engagement is able to transmit to the support the movement rotating on itself of the driving member. The driving member and support are for example connected to each other in rotation either by fitting together, by plugging, by pinning, by keying, by fluting or any other similar technique of rotational assembly.

The advantageous solution consisting of mounting the actuator on the chassis and engaging its output shaft with the support is preferred. These arrangements improve the reduction of the space requirement of the mounting means by pivoting the optical module on the chassis.

More particularly, the driving member comprises, and is preferably formed by, an output shaft of the actuator.

The output shaft is able to be oriented along an axis different from that of the movement generated by the motor member that comprises the actuator. The actuator comprises, or more particularly consists of, an independent module that can be attached per se to the chassis. Such a module is able to integrate not only the motor member generating the movement of the output shaft of the actuator but also means of returning this movement to the output shaft in order to cause its rotation on itself. The actuator is advantageously attached to the chassis laterally with respect to the axial extension of the output shaft. This addition of the actuator is for example achieved by clipping or a similar technique of putting in cooperation fitting-together members which the chassis and the actuator have respectively. Other addition techniques can be envisaged, in particular techniques using specific assembly members or using a plugging between the chassis and the actuator.

According to one embodiment in which the articulation axis of the bearing is off-center with respect to the pivot axis of the optical module, the driving member comprises, or in particular consists of, a notched member, such as a wheel, rack or similar notched member, which cooperates with the fins of a heat sink that the optical module has.

The suitability of the mounting means for using an articulation axis of the support off-center with respect to the pivot axis of the optical module reveals the general result procured by the invention on the freedom of arrangement and location of the single articulation bearing and of the chassis organized as a pedestal.

The heat sink may be a member of the type comprising fins or similar elements able to optimize the heat exchange surface between the optical module and the ambient air. Such a heat sink is used for the cooling of the optical module, and consequently of the heat in particular produced by the light source.

The light source can be chosen from light emitting diodes (LEDs), discharge lamps, also referred to as xenon lamps, or halogen lamps, or even any other type of light source suitable for obtaining a light beam adapted for lighting the road or for the signalling of the vehicle.

It is however preferred to use a light source of the light emitting diode (LED) type, which has the advantage of obtaining an optical module of low weight and reduced axial extension along the optical axis of the light beam produced and returned towards the transparent wall. The choice of using such a light source makes it possible in particular to lighten the optical module and to allow its support by the pedestal without affecting the precision of its mobility in pivoting, despite its articulation on the chassis from a single bearing placed at its base.

More particularly, the light source is of the light emitting diode (LED) type. In this case, the support advantageously comprises a carrier body having:

in its front zone at least one light emitting diode constituting the light source, and a single-part element constituting the optical system allocated to the light emitting diode (LED),

in any other of its areas, means of cooling the heat produced by the light source, or even also the connections connecting the optical module to the vehicle energy source. Such cooling means associate for example a heat sink (also referred to as a radiator) and a fan, or are of the type using a refrigerated heat-transfer fluid.

The other one of the areas of the body is in particular its rear area for best balancing the supporting of the support in its middle area. The front and rear areas are the areas of the support that are distributed on each side of the axis of the articulation bearing and more particularly the pivot axis of the optical module. The front area corresponds to the area of the support lying between said pivot axis and the transparent wall of the headlight. This front area can easily be masked by a frontal mask mounted so as to be able to move on the optical module while being carried by the support so as to reveal only an end reflector of the optical system.

Preferably, an axial rubbing part is interposed between the support and the pedestal. This axial rubbing part forms the articulation bearing and is able to relieve the pedestal of the consequences caused by the abutment of the optical module on the seat. Such an axial rubbing part is for example formed by a wearing part or a part provided with rolling members, such as a needle bearing or the like. Such parts are for example formed by the shouldering of an interposition ring slipped inside the passage that the pedestal has for receiving the driving member, and more particularly the output shaft of the actuator.

The extension and size of the mounting means have no effect on the organization of the top area of the headlight situated overhanging the optical module, and in particular on the installation of at least one mask forming a visual obstacle to the top area of the optical module. This area being left clear, the installation of at least one top mask in this area is facilitated and the number of masks necessary can easily be reduced. In particular the presence of additional masks for interposing between the movable mask or masks and the fixed mask or masks is made unnecessary for reducing the clearances or at the very least their appearance.

More particularly, the headlight comprises at least one movable mask that is carried by the optical module with which it moves. This movable mask is able to comprise, in isolation or in combination, one or more top movable masks and one or more bottom movable masks.

At least one movable mask can be installed on the optical module and be associated with at least one fixed mask carried by the headlight housing. The clearance between the movable mask and the fixed mask necessary for the pivotal mobility of the optical module can be made invisible to an observer by placing the corresponding edge of the fixed mask in a rear corner of the movable mask, without increasing the overall size of the optical module carrying the movable mask or masks. The invisibility of the clearance between movable mask and fixed mask can be obtained including in the case where the transparent lens is highly curved with a respect to the resting plane of the vehicle on the ground when the headlight is installed on the latter. A particular aesthetic effect can easily be conferred on the headlight from this invisibility of clearance between the fixed mask or masks and the movable mask or masks. This aesthetic effect can result from a moving appearance of the optical module provided with a movable mask, without the clearances between this movable mask and the associated fixed mask being at least partly visible. The movable mask can also be freely conformed, in particular in the upper area of the optical module that is left clear.

For example, the headlight is advantageously equipped with at least one movable mask comprising, in isolation or in combination:

a movable top mask that provides a rear corner for receiving the edge of a fixed top mask carried by a housing of the headlight. This rear corner is disposed in an area of the optical module invisible to an observer from the outside of the headlight through the transparent wall. The clearances necessary for the mobility of the optical module between the movable top mask and the fixed top mask are invisible to this observer; and

a movable bottom mask that extends substantially orthogonally to the optical axis of the light beam and that preferably cooperates with a fixed bottom mask. This fixed bottom mask is carried by a housing of the headlight and is oriented substantially orthogonally to the movable bottom mask.

The movable top mask forms an envelope covering the upper part of the optical module opposite to its area of support by the pedestal, and preferentially covering its lateral parts towards the pedestal. The movable bottom mask is placed in front of the optical module extending laterally in order to form an envelope covering the support, or even also at least partially the pedestal. The movable bottom mask has a curved conformation and the fixed bottom mask comprises a window having a homothetic curve conformation. The center of curvature of these curved conformations is placed on the pivot axis of the optical module with the advantage of best producing the clearance between the movable bottom mask and the fixed bottom mask.

The various masks (top, bottom, or even lateral) can be separate components or be made in a single part.

These and other objects and advantages of the invention will be apparent from the following description, the accompanying drawings and the appended claims.

### BRIEF DESCRIPTION OF THE ACCOMPANYING DRAWINGS

The present invention will be better understood from a reading of the description that will be given of non-limitative example embodiments in relation to the figures of the accompanying drawings, in which:

FIGS. 1 to 3 are perspective illustrations of different respective variant embodiments of a mounting device according to the present invention;

FIGS. 4 and 5 are illustrations in axial section of the mounting devices shown respectively in FIG. 1 and FIG. 2;

FIG. 6 is a perspective illustration of a chassis constituting a mounting device of the present invention; and

FIGS. 7 and 8 illustrate another variant according to the invention.

### DETAILED DESCRIPTION OF THE PREFERRED EMBODIMENTS

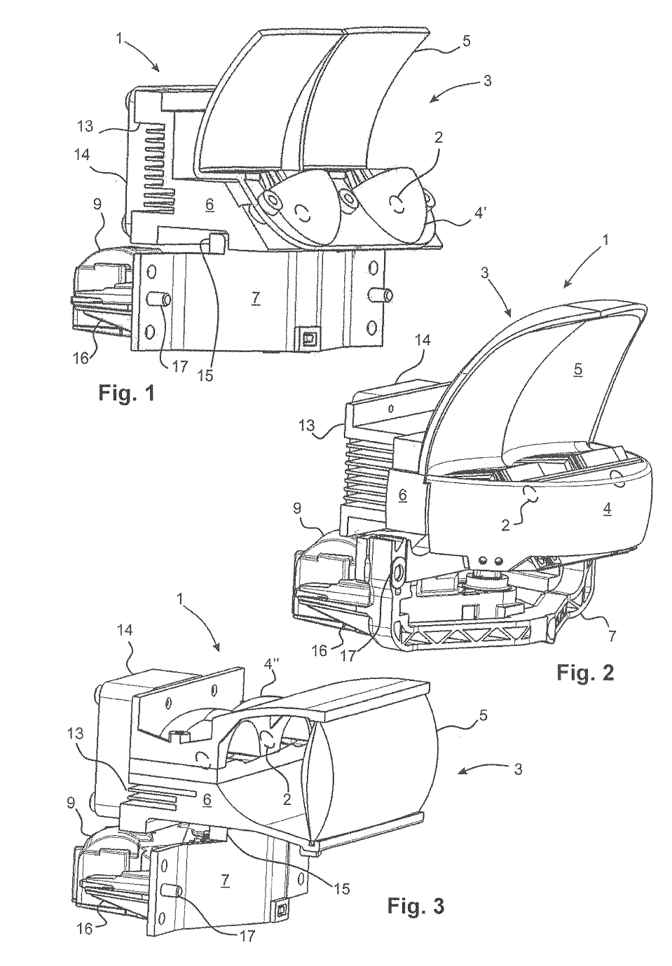

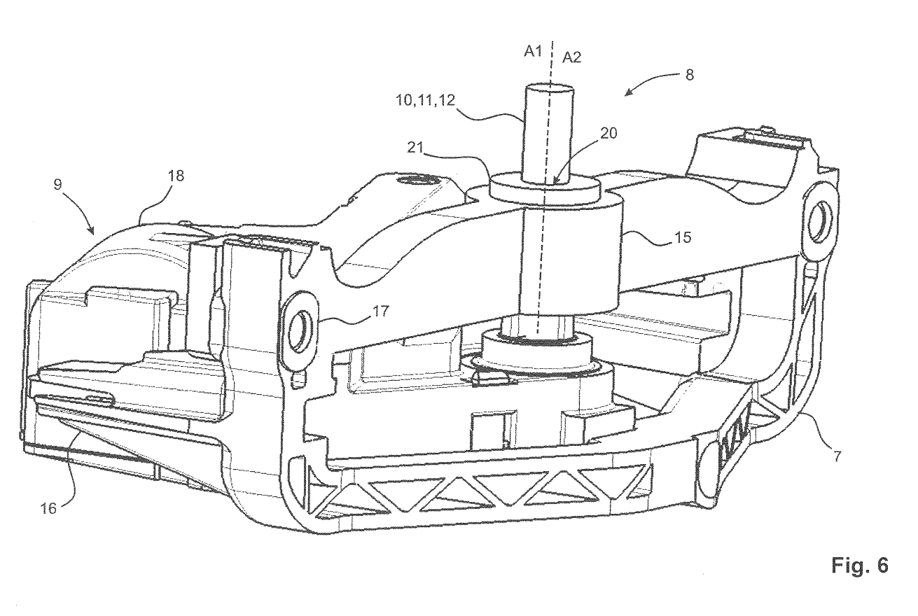

In FIGS. 1 to 6, an articulated mounting device of an optical module 1 is intended to equip a headlight for a motor vehicle. The optical module 1 is principally composed of at least one light source 2 consisting of one or more light emitting diodes (LEDs), and an optical system 3 associating reflectors 4, 4′, 4″, 5 allocated to the light source 2. The articulated mounting of the optical module 1 about a pivot axis A1 is intended to confer on the headlight to so-called “bending light” function. This articulated mounting is effected using a support 6 that the optical module 1 comprises, which is mounted so as to be able to move pivoting on a chassis 7 of the headlight about an articulation axis A2 formed by a single bearing 8. The support 6 is maneuverable pivotally by means of an actuator 9. For practical reasons of assembly, the spindle 10, 11, 12 can consist of two distinct elements, as shown in FIG. 6, the articulation member 11 on the bearing 8 side and the other the output shaft 10 forming part of the actuator 9, the transmission member 12 serving to transmit the movement to the optical module 1. The articulation bearing 8 makes it possible to take up the axial and radial forces due to the optical module 1 and thus separate the drive members from the force chains. Consequently the bearing 8 associated with a pedestal 15 of a chassis 7 supports the weight of an optical module 1 and its associated forces, and an actuator 9 generates solely a rotation movement. Because of this, the actuator 9 needs minimum force to make the support 6 pivot. The support 6 is situated in a longitudinally median area of the optical module 1 along the optical axis A3 of the light beam produced. The support 6 carries in its front area the light source 2 and a single-part element constituting the optical system 3, and in its rear area means of cooling the heat produced by the light source 2. In the example embodiment illustrated, these cooling means associate a heat sink 13 with fins and a fan 14. It is nevertheless possible to use other types of cooling means, in particular by the circulation of cooled refrigerant fluid.

The optical module 1 is mounted so as to pivot on the chassis 7 about a pivot axis A1, which is coaxial with the articulation axis A2 of the single bearing by means of which the support 6 is articulated on the chassis 7. The optical module 1 is disposed overhanging the chassis 7 so that the chassis 7 forms a support foundation for the optical module 1 and so that the opposite top part of the optical module 1 is left clear.

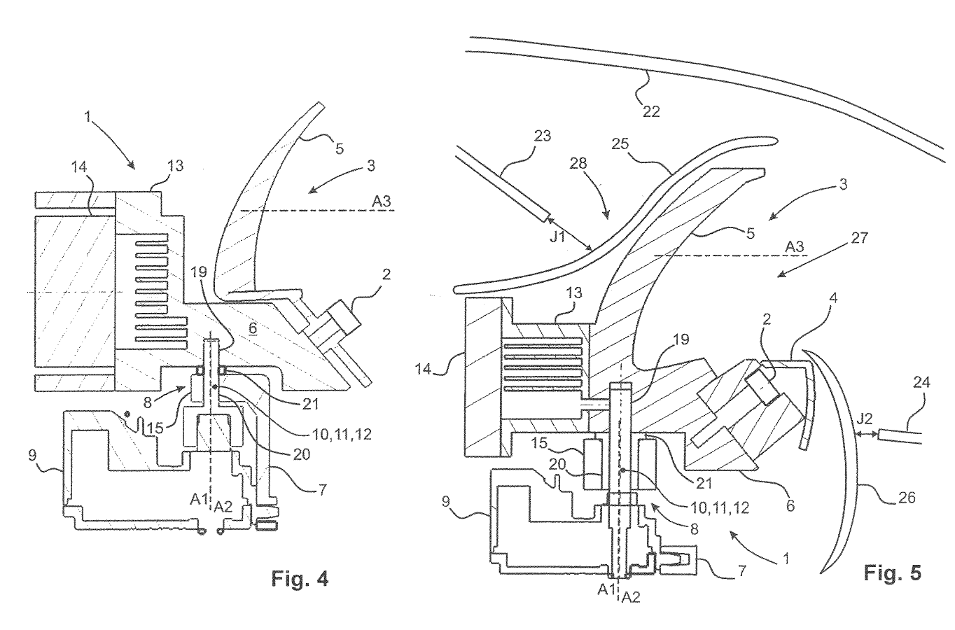

The chassis 7 is formed by a framework that is provided with a pedestal 15 supporting the optical module 1 by means of its support 6. This framework extends roughly in a plane containing the pivot axis A1 of the optical module 1 and more particularly also the axis A2 of the articulation bearing. This framework is for example arranged as a plate, as illustrated in FIG. 1 and FIG. 3, or as a rigid frame composed of beams or the like connected together, as illustrated in FIG. 2 and FIG. 6. In FIG. 6 in particular, the chassis 7 is provided with means 16 of receiving the actuator 9 by clipping, laterally with respect to the extension of the output shaft 10, and means 17 of fixing on a housing of the headlight, not shown. The actuator 9 constitutes a module that can be attached to the chassis 7, and includes a motor member 18 that is in relationship with the output shaft 10 by means of a transmission system, not shown. The shaft of the motor member 18 of the actuator 9 is oriented in a direction from that of the output shaft 10, which makes it possible to place the actuator 9 laterally on the chassis 7 without forming an obstacle to the use of the output shaft 10 to form both the driving member 12 in engagement on the support 6 and the articulation member 11 of the bearing 8 able to cooperate with a complementary articulation member 19 (FIGS. 4 and 5) that the support 6 has.

In FIG. 5 more particularly, the articulation member 11 can be mounted slidably with respect to an articulation bearing 8. The articulation bearing 8 associates the pedestal 15, which provides a supporting seat for the support 6 and which comprises a passage 20 for the output shaft 10 of the actuator 9. The output shaft 10 is in engagement on the support 6 while being fitted inside a housing which receives it and which constitutes the complementary articulation member 19. The guidance of the support 6 in articulation is achieved solely from its engagement on the output shaft 10 of the actuator 9. The output shaft 10 of an actuator 9 can in particular have a vertical clearance in order to facilitate mounting of the device and also enable the bearing 8 to naturally take up the forces relating to the optical module 1. Other methods of putting the support and output shaft in mechanical relationship can be envisaged, such as keying, fluting or similar technique.

An axial rubbing part 21 is interposed between the support 6 and the pedestal 15. This rubbing part 21 consists for example of a needle or ball bearing, as illustrated in FIG. 4, or a shouldered wearing ring slipped inside the passage 20 that the base 6 has as illustrated in FIG. 5.

In FIG. 5, the headlight is provided with a set of masks to form an obstacle to visual access to the members of the headlight deemed unaesthetic, such as in particular the optical module 1 with the exception of the end reflector 5 constituting the optical system 3. It is particularly sought to form such a visual obstacle towards the inside of the headlight through a transparent wall 22 that the headlight has for the exit of the light beam. The set of masks associates fixed masks 23, 24 carried by the headlight housing and movable masks 25, 26 carried by the optical module 1. The arrangement of these masks with respect to each other makes it possible to provide a window 27 through which the light beam is able to be returned to the transparent wall 22 for its exit out of the headlight.

The pivotal mobility of the optical module 1 is wished to be as ample as possible, with the consequence of having to provide sufficient clearances J1 and J2 between the fixed masks 23, 24 and the movable masks 25, 26. These clearances J1 and J2 constitute interstices that affect the aesthetic appearance of the headlight. In addition, the visible external appearance of the optical module 1 depends on the external appearance combining the movable masks 25, 26 and the end reflector 5. Leaving clear the top area of the optical module 1 makes it possible to freely arrange a movable top mask 25 enveloping the optical module 1. This freedom makes it possible in particular to provide a rear corner 28 on the movable top mask 25, towards the inside of which the edge of a fixed top mask 23 is placed. The clearance J1 provided between the movable mask 25 and the fixed top mask 23 is able to be invisible from the outside of the headlight through the transparent wall 22. A movable bottom mask 26 is installed on the optical module 1, extending in a direction substantially orthogonal to the optical axis A3 of the light beam. This movable bottom mask 26 is slightly curved and is placed at the front of the optical module 1, interposed between the latter and the transparent wall 22, in order to conceal the base of the support 6 and possible the pedestal 15. The movable bottom mask 26 cooperates with a fixed bottom mask 24 carried by the headlight housing. This fixed bottom mask 24 is substantially oriented parallel to the optical axis A3 of the light beam, being slightly inclined in order to prevent undesirable reflection of the light produced by the optical module 1. The clearance J2 between the fixed bottom mask 24 and the movable bottom mask 26 is able to be small because of the respective conformations and orientations of these masks with respect to the orientation of the pivot axis A1 of the optical module 1. In particular, the movable bottom mask 26 has a curved conformation whose center of curvature is situated on the pivot axis A. The edge of the window that the fixed bottom mask 24 has a conformation similar to the curvature of the movable bottom mask 26. The clearance J2 is only a little or not at all perceptible to an observer through the transparent wall 22, even it the latter is highly curved with respect to the resting plane of the vehicle on the ground.

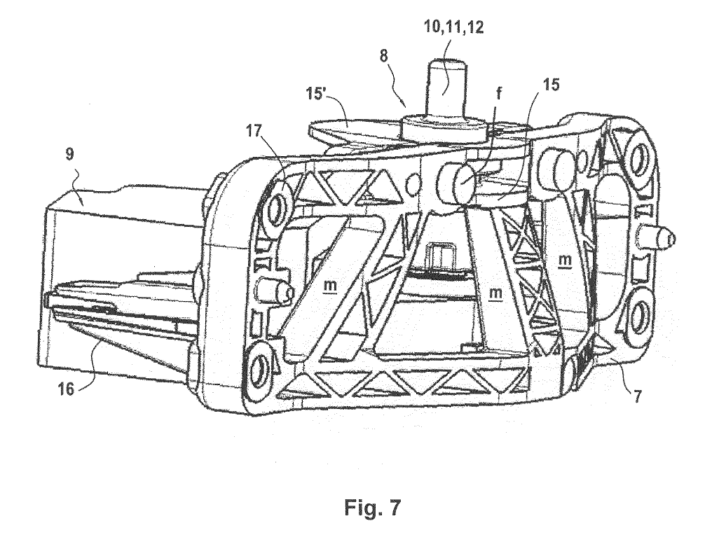

FIG. 7 depicts a perspective view of a variant of the chassis according to FIG. 6: the same references are used. This variant adds in particular three uprights m, two lateral and one central, to the chassis 7 in order to improve its mechanical rigidity. The pedestal 15 is broken down in to two parts 15 and 15′, a fixing means of the screw type F is provided for fixing the part 15′ to the chassis 7.

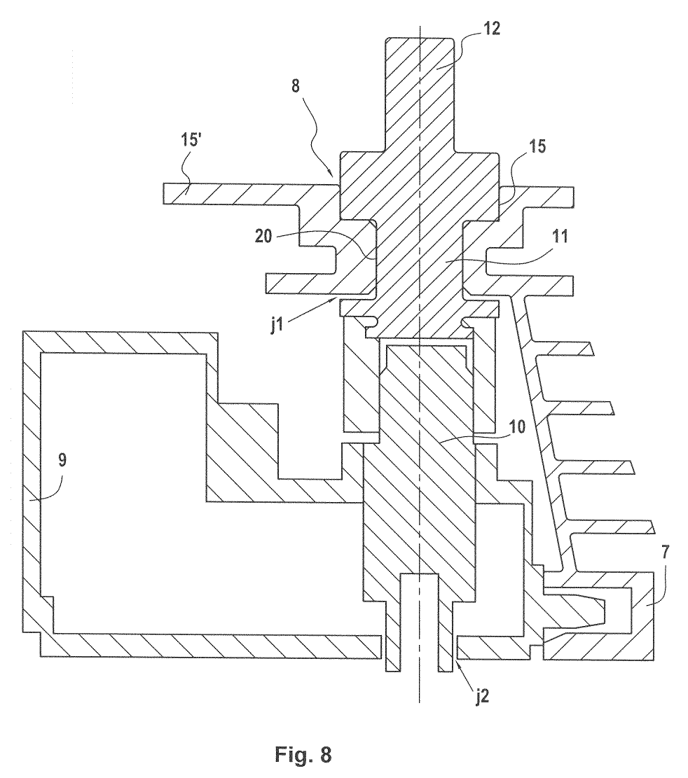

FIG. 8 is a view in cross-section of the elements shown in FIG. 7: the spindle 10 is the spindle of the actuator 9, which allows rotation of the bearing. The spindle 12 transmits the rotation movement to the support 6. The entire weight of the module rests on the base 15, 15′, in its contact zone with the spindle 12. A vertical clearance j1 is visible in the figure between the pedestal and the shaft 12. Another clearance j2 is provided between the actuator 9 and its spindle 10.

While the form of apparatus herein described constitutes a preferred embodiment of this invention, it is to be understood that the invention is not limited to this precise form of apparatus, and that changes may be made therein without departing from the scope of the invention which is defined in the appended claims.

What is claimed is:

1. A headlight for a motor vehicle equipped with an optical module comprising a support carrying a light source and an optical system for emitting a light beam, the optical module being mounted so as to be able to move on the headlight about a pivot axis through mobility means that associate pivoting means of mounting the support on a chassis of the headlight using an actuator in relationship with at least one driving member in engagement on the support wherein the pivoting mounting means of the support comprises a single articulation bearing:
situated below and supporting the optical module,
taking up the forces, in particular axial and radial, due to the optical module and thus separating the drive member or members of the force chains.

2. The headlight according to claim 1, wherein the optical module is disposed above, in particular in cantilever over or overhanging, the chassis, which is formed by a framework provided with the pedestal at its top.

3. The headlight according to claim 1, wherein the articulation axis of the bearing is coaxial or off-center with respect to the pivot axis of the optical module.

4. The headlight according to claim 1, wherein the chassis extends in a plane containing the pivot axis.

5. The headlight according to claim 1, wherein the pedestal comprises a passage for the driving member that is coaxial with the axis of the articulation bearing that it constitutes and that is maneuverable in rotation on itself by the actuator.

6. The headlight according to claim 1, wherein the driving member comprises an output shaft of the actuator.

7. The headlight according to claim 1, wherein the driving member comprises a notched member that cooperates with the fins on a heat sink that the optical module has.

8. The headlight according to claim 1, wherein the light source is chosen from at least one light emitting diode, a xenon discharge lamp and a halogen lamp.

9. The headlight according to claim 8, wherein the light sources comprises at least one light emitting diode, and in that the support consists of a body carrying:
in its front zone at least one light emitting diode constituting the light source, and a single-part element constituting the optical system allocated to the light emitting diode;
in any other of its zones, means of cooling the heat produced by the light source.

10. The headlight according to claim 1, wherein an axial rubbing part is interposed between the support and the pedestal.

11. The headlight according to claim 1, wherein at least one movable mask is carried by the optical module with which it moves.

12. The headlight according to claim 11, wherein the at least one movable mask comprises a movable top mask that forms a rear corner receiving the edge of a fixed top mask carried by a housing of the headlight.

13. The headlight according to claim 11, wherein the at least one movable mask comprises a movable bottom mask that extends substantially orthogonally to the optical axis of the light beam and that preferably cooperates with a fixed bottom mask carried by a housing of the headlight and oriented substantially orthogonally to the movable bottom mask.

14. The headlight according to claim 1, wherein the headlight is provided with an optical module pivotally mounted on the pedestal according to an angular movement able to procure, from this same optical module, the “conventional low” function and the “bending light” function.

15. The headlight according to claim 1, wherein the optical module is carried by an intermediate chassis itself carried by a chassis common to several optical modules, and in that it comprises a dedicated leveling means, in particular a dynamic leveler.

16. The headlight according to claim 2, wherein the articulation axis of the bearing is coaxial or off-center with respect to the pivot axis of the optical module.

17. The headlight according to claim 16, wherein the chassis extends in a plane containing the pivot axis.

18. A headlight for a motor vehicle equipped with an optical module comprising:
a support carrying a light source and an optical system for emitting a light beam, the optical module being pivotably mounted so as to be able to move about a pivot axis; said support further comprising at least one articulation member that is:
situated below and supporting the optical module,
taking up forces, in particular axial and radial, due to the optical module and thus separating at least one drive member that is in engagement with the support and that drives said optical module.

19. The headlight according to claim 18, wherein the optical module is disposed above, in particular in cantilever over or overhanging, a chassis of the headlight, which is formed by a framework provided with a pedestal at its top.

20. The headlight according to claim 18, wherein the articulation axis of the articulation member is coaxial or off-center with respect to the pivot axis of the optical module.
